(19) United States
(12) Patent Application Publication
(10) Pub. No.: US 2016/0180059 A1
(43) Pub. Date: Jun. 23, 2016

(54) METHOD AND SYSTEM FOR GENERATING A REPORT FOR A PHYSICAL ACTIVITY

(71) Applicant: Vibrado Technologies, Inc., Sunnyvale, CA (US)

(72) Inventors: Cynthia Kuo, Mountain View, CA (US); Quinn A. Jacobson, Sunnyvale, CA (US)

(21) Appl. No.: 14/971,590

(22) Filed: Dec. 16, 2015

Related U.S. Application Data
(60) Provisional application No. 62/093,190, filed on Dec. 17, 2014.

(51) Int. Cl. G06F 19/00; G06K 9/00

(52) U.S. Cl. CPC G06F 19/3481; G06K 9/00342

(57) ABSTRACT

Sensors can be used to monitor repeated performances of a physical activity. Data from the sensors are used to generate a report, which may include a video recording of the person performing the physical activity repeatedly, a performance quality attribute indicating desirability of how the physical activity was performed by the person, and/or a recommendation for improving the performance quality attribute.

### CROSS-REFERENCE TO RELATED APPLICATION

This application claims the benefit of U.S. Provisional Application No. 62/093,190, filed Dec. 17, 2014, which is incorporated herein by reference in its entirety and for all purposes.

### FIELD

The invention relates, in general, to data processing and, more particularly, to generating a report for a physical activity according to collected sensor data.

### BACKGROUND

There exist technological solutions for observing the biomechanical actions of an individual or group of individuals. Wearable technology, like the Nike Fuelband®, can recognize and record what activities an individual is doing. New multi-sensor wearable systems from companies like Vibrado Technologies can go beyond recognizing what an individual is doing and also observe and track how well they are doing something by observing and analyzing an individual's biomechanics in real-time. Solutions from companies like Catapult and others can track teams of players, observing there level of activity and in some cases even tracking there position within the field of play.

Video capture systems, like the SportVU® system from STATS, can also observe the activity of individuals or teams. And with today's sophisticated image recognition the systems can even interpret some players' motion and actions. And with 3-D imaging systems the potential is there to capture the biomechanics of individuals and teams in real-time.

These systems can perform complex analysis of what people are doing. And these systems can generate a tremendous amount of interesting data about what an individual is doing, how well he/she is doing it, and what could or should be done differently. This data has the potential to inform, influence and motivate individuals. Especially relevant is the opportunity to encouraging individuals to participate in more, and get more from, fitness and sports activities.

But few individuals want to look at lots of graphs and tables. And fewer still find graphs of information particularly influential or motivating. So there are people who buy fitness trackers and sports training aids that end up sitting unused in drawers.

Another method for individuals or coaches to gather information about an athlete's performance is through video recordings. It is common practice to take video recording of athletes performing actions and then review the video to critique performance. There are very helpful tools, like Coach's Eye®, to help edit, review and annotate video recordings. There are also methods developed by Vibrado Technologies to simplify and increase the efficiency of video recording and editing by having systems that automatically find the most relevant segments of video by using information from wearable sensors. Even with all the tools available, watching video of oneself for sports can be tedious and few people use this powerful tool significantly.

What is needed is a way to transform data, from wearable sensors and/or a camera, into a compelling and personalized infotainment experience, thereby producing content that conveys the information in an entertaining way.

### SUMMARY

Briefly and in general terms, the present invention is directed to a method and system for generating a report for a physical activity.

In aspects of the present invention, a method comprises receiving sensor data from at least one sensor located on a person performing a physical activity, the sensor data including biomechanical data obtained during the physical activity. The method also comprises interpreting the sensor data, the interpreting performed by a processor, the interpreting including determining, from the sensor data, a performance quality attribute indicating desirability of how the physical activity was performed by the person. The method also comprises generating a report that includes a plurality of information elements capable of being presented on a presentation device, wherein the performance quality attribute is represented by at least a first one of the information elements.

In aspects of the present invention, a system comprises a means for receiving sensor data from at least one sensor to be placed on a person performing a physical activity, the sensor data including biomechanical data obtained during the physical activity. The system also comprises a means for interpreting the sensor data, the interpreting including determining, from the sensor data, a performance quality attribute indicating desirability of how the physical activity was performed by the person. The system also comprises a means for generating a report that includes a plurality of information elements capable of being presented on a presentation device, wherein the performance quality attribute is represented by at least a first one of the information elements.

In aspects of the present invention, a non-transitory computer readable medium has a stored computer program embodying instructions, which when executed by a computer system, causes the computer system to generate a report for a physical activity. The computer readable medium comprises instructions for receiving sensor data from at least one sensor to be placed on a person performing a physical activity, the sensor data including biomechanical data obtained during the physical activity. The computer readable medium also comprises instructions for interpreting the sensor data, the interpreting including determining, from the sensor data, a performance quality attribute indicating desirability of how the physical activity was performed by the person. The computer readable medium also comprises instructions for generating a report that includes a plurality of information elements capable of being presented on a presentation device, wherein the performance quality attribute is represented by at least a first one of the information elements.

The features and advantages of the invention will be more readily understood from the following detailed description which should be read in conjunction with the accompanying drawings.

### BRIEF DESCRIPTION OF THE DRAWINGS

FIG. 1 is a flow diagram showing an exemplary method for correlating a video recording with sensor data.

FIG. 2 is a schematic diagram showing a video recording and sensor data produced over time

FIG. 3-5 are schematic diagrams showing exemplary systems for generating a report for a physical activity using the sensor data and optionally the video recording.

FIG. 6 is a schematic diagram showing portions of the video recording and the sensor data.

FIG. 7 is a photograph showing a person wearing sensors for producing sensor data.

FIG. 8 is a flow diagram showing an exemplary method for generating a report for a physical activity using the sensor data and optionally the video recording.

FIG. 9 is a schematic representation of report templates used for generating a report.

FIG. 10 is a schematic representation of a presentation device for communicating the report to a person.

### INCORPORATION BY REFERENCE

All publications and patent applications mentioned in the present specification are herein incorporated by reference to the same extent as if each individual publication or patent application was specifically and individually indicated to be incorporated by reference. To the extent there are any inconsistent usages of words and/or phrases between an incorporated publication or patent and the present specification, these words and/or phrases will have a meaning that is consistent with the manner in which they are used in the present specification.

### DETAILED DESCRIPTION OF EXEMPLARY EMBODIMENTS

Wearable sensor technology can be used to help athletes analyze their form. Wearable sensors can be integrated into garments to capture the motion of an athlete. The data from the sensors can be analyzed in real-time to provide immediate feedback to athletes. The data can also be reviewed later by the coach and/or athlete to help the athlete understand their form and identify how to improve.

Creating a video recording of an athlete training while wearing a wearable sensor system can be a very powerful combination. If the timing of the video and sensors data can be correlated, there is a range of capabilities that can be enabled.

There are a number of ways to correlate the video recording to the sensor data. This can be done if a modern smart phone or tablet computer is used that is capable of both video recording and connecting wirelessly to the wearable sensors. In this case, a common reference time can be created between the video recording and the sensor data; both are time stamped based on the device's internal clock. Alternatively, a camera that directly connects to the wearable sensors (or that connects to a device connected to the wearable sensors) can enable a time stamping of the video recording and the sensor data to be correlated so that equivalent points can be readily found. In general, any method where a sequence of video can be correlated with a sequence of sensor data without human intervention so that the same point in time can be readily identified in both, within a reasonable margin, can be implemented.

With the correlation of the video recording and wearable sensor data, there are a number of key capabilities that can be enabled. One such capability is to use the sensor data to identify the most representative cases of either or both good and/or bad form. As used herein, the term “form” refers to biomechanical form unless indicated otherwise. Determining good or bad form is application dependent (e.g., dependent upon the type of activity or situation), but it can be represented by any of set of heuristics that interpret the sensor data. For example, a heuristic for a basketball shot performed with good form may include a predetermined range of angles for each of the upper arm, forearm, and wrist. When sensor data provides angles within the predetermined range, the system will identify the corresponding video segment that is expected to show good form. Various types of wearable sensors can be used to identify good (or desirable) and bad (or undesirable) form. Examples of wearable sensors are described below. Once the representative cases are identified, the corresponding video segments can be automatically identified and included in a report unique to the person.

Another capability that can be enabled by correlating sensor data with video is the ability to augment the report with additional information. Wearable sensors can capture a range of biometric and biomechanical data. This data may include measurements of heart rate, respiratory rate, joint angles, muscle activity, and/or muscle fatigue. Augmenting the report with biometric or biomechanical data from the wearable sensors provides a valuable service to help athletes understand their form and how to improve.

Another capability that can be enabled by correlating sensor data with video is the ability to identify the best and worst examples in the video and use that information to help the wearable sensor learn the athlete and automatically tune its heuristics to the athlete. This is important for more advanced athletes where wearable sensors will be used to help improve consistency as opposed to teaching biomechanical form.

Although the discussion above focused on wearable sensors and video to help athletes improve their performance, the same approach can be used to help patients with physical therapy and rehabilitation.

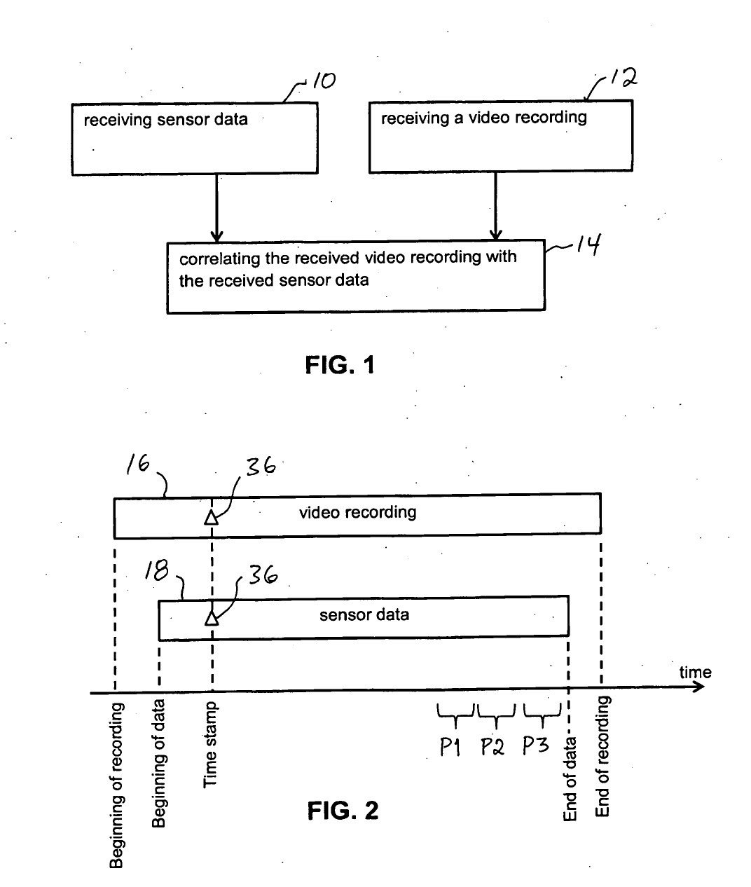

Referring now in more detail to the exemplary drawings for purposes of illustrating exemplary embodiments of the invention, wherein like reference numerals designate corresponding or like elements among the several views, there is shown in FIG. 1 a flow diagram showing an exemplary method for correlating a received video recording with received sensor data. In block 10, sensor data is received. The sensor data includes biometric and/or biomechanical data produced during periods of time from at least one sensor located on a person performing a physical activity.

Examples of physical activities include without limitation, shooting a basketball into a hoop, pitching a baseball, swinging a golf club, baseball bat, tennis racket, hockey stick, or other type of equipment, and kicking a football. The physical activity does not need to be sporting activity. The physical activity can be one that is performed for physical therapy or rehabilitation. The physical activity can be an exercise designed to help the person recover strength or mobility. The physical activity can be an everyday task, such as walking, running, lifting a spoon or glass toward one's mouth, etc., which the person may have difficulty in performing due to injury, disease, or other condition.

As indicated above, one or more sensors are located on the person. For example, one or more of the sensors can be (1) attached directly onto the person's skin, (2) attached to an article of clothing so that the sensor is in direct contact with skin, and/or (3) attached to an article of clothing so that the sensor is not in direct contact with skin. The type and functional capabilities of the sensor will dictate whether the sensor should be in contact with the skin or whether the sensor can be at some distance from the skin.

One or more of the sensors can be located on the person's arm, leg, and/or torso. The location and the total number of sensors will depend upon the type of physical activity that is being evaluated. Positioning of various sensors at different areas of a person's body is described in U.S. Patent Application Publication No. 2014/0163412, which is incorporated herein by reference.

One or more of the sensors can include an inertial measurement unit (IMU) configured to detect motion of the body. The IMU can be the ones described in U.S. Patent Application Publication No. 2014/0150521 (titled “System and Method for Calibrating Inertial Measurement Units), which is hereby incorporated herein by reference. An IMU is configured to provide information on its orientation, velocity, and acceleration. An IMU may include gyroscopes, accelerometers, and/or magnetometers. A gyroscope is configured to measure the rate and direction of rotation. An accelerometer is configured to measure linear acceleration. A magnetometer is configured to detect direction relative to magnetic north pole.

One or more of the sensors can include a myography sensor configured to detect whether a particular muscle is being used by the person and optionally how fatigued that muscle is. Myography sensors include sensors configured to provide signals indicative of muscle contraction, such as signals corresponding to electrical impulses from the muscle, signals corresponding to vibrations from the muscle, and/or signals corresponding to acoustics from the muscle, as described in U.S. Patent Application Publication No. 2014/0163412 (titled “Myography Method and System”), which is hereby incorporated herein by reference. Other exemplary myography sensors include those described in U.S. Patent Application Publication Nos. 2010/0262042 (titled “Acoustic Myography Systems and Methods”), 2010/0268080 (titled “Apparatus and Technique to Inspect Muscle Function”), 2012/0157886 (titled “Mechanomyography Signal Input Device, Human-Machine Operating System and Identification Method Thereof”), 2012/0188158 (titled “Wearable Electromyography-based Human-Computer Interface), 2013/0072811 (titled “Neural Monitoring System”), and 2013/0289434 (titled “Device for Measuring and Analyzing Electromyography Signals”), which are hereby incorporated herein by reference.

Myography sensors include without limitation a receiver device configured to detect energy which has passed through the person's body or reflected from the person's body after having been transmitted by a transmitter device. The receiver device need not be in contact with the person's skin. Myography sensors with these types of receiver and transmitter devices are described in U.S. Patent Application Publication No. 2015/0099972 (titled “Myography Method and System”), which is incorporated herein by reference. The type of energy transmitted by the transmitter device and then received by the receiver device includes without limitation sound energy, electromagnetic energy, or a combination thereof, which are used to infer vibrations occurring on the skin surface, below the skin surface, or in the muscle which naturally arise from muscle contraction. For example, the transmitter device can be configured to transmit (and receiver device can be configured to detect) audio signals, which can include acoustic waves, ultrasonic waves, or both. Acoustic waves are in the range of 20 Hz to 20 kHz and include frequencies audible to humans. Ultrasonic waves have frequencies greater than 20 kHz. Additionally or alternatively, transmitter can be configured to transmit (and receiver 16 can be configured to detect) radio waves. For example, radio waves can have frequencies from 300 GHz to as low as 3 kHz. Additionally or alternatively, the transmitter device can be configured to transmit (and receiver device can be configured to detect) infrared light or other frequencies of light. For example, infrared light can have frequencies in the range of 700 nm to 1 mm. These types of energy, after having passed through the person's body or reflected from the person's body, are analyzed by processor device 32 to infer muscle contraction and/or muscle fatigue.

As indicated above, the sensor data produced by the one or more sensors data includes biometric and/or biomechanical data. Examples of biometric data include without limitation heart rate and respiratory rate. Examples of biomechanical data include without limitation joint angles, muscle activity (e.g., isometric muscle contraction, concentric muscle contraction, and eccentric muscle contraction), muscle fatigue (e.g., inferred from a change in the intensity of muscle contraction, a time domain signature of muscle contraction, and a frequency domain signature of muscle contraction), level of acceleration of a part of the person's body, and/or direction of movement of a part of the person's body.

In FIG. 1, block 12, a video recording is received. The video recording can be received simultaneously with receiving the sensor data. Alternatively, the video recording can be received at a different time from when the sensor data is received. The video recording is produced during the periods of time in which the sensor data was produced. The video recording shows the person performing the physical activity from which the sensor data was taken.

In block 14, the video recording that was received is correlated with the sensor data that was received. This facilitates matching portions of the video recording with portions of the sensor data that were produced during corresponding periods of time. The correlation step can be performed at some period of time after the sensor data and/or the video recording was completely received. Alternatively, the correlation step can be performed while the sensor data and/or the video recording are being received.

As shown for example in FIG. 2, a camera may start producing video recording 16 before any of the sensors start producing sensor data 18. Thus, data at the beginning of the sensor data stream would not correspond to video images at the beginning of the video recording. This difference in timing is taken into account by correlating the video recording with the sensor data so that equivalent points (i.e., points corresponding in time) in video recording 16 and sensor data 18 can be readily found. There are a number of ways to correlate video recording 16 to sensor data 18.

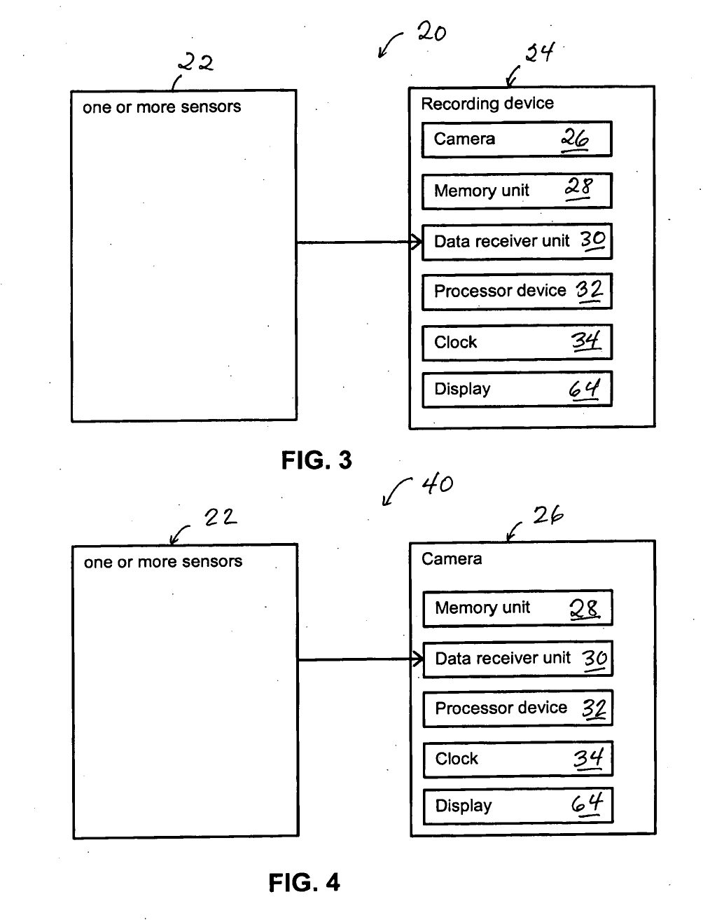

FIG. 3 shows system 20 for generating a report for a physical activity. System 20 includes one or more sensors 22 and recording device 24. One or more sensors 22 can be as previously described above or elsewhere herein. For example, all sensors 22 can be myography sensors configured to detect muscle activity (muscle contraction and/or fatigue). Alternatively all sensors 22 can be IMUs or other sensors configured to detect movement of a limb, including acceleration and direction of movement. Alternatively, some sensors 22 can be myography sensors while other sensors 22 are sensors configured to detect movement of a limb, including acceleration and direction of movement.

Although the one or more sensors 22 are illustrated schematically as a single box, it is to be understood that the box can represent any number of sensors which may be located on any number of areas of the person's body. Recording device 24 is a multifunctional device, such as a smart phone, tablet computer, laptop computer, or desktop computer. A smart phone is an electronic device capable of making telephone calls and is capable of receiving data using Bluetooth or other wireless communication protocol. Wireless communication means transmission of data through the air. Recording device 24 includes camera 26 configured to record video images which are stored in memory unit 28. Memory unit 28 can include volatile memory components and/or non-volatile memory components. Memory unit 28 can store data in digital or analog form. Recording device 24 also includes receiver unit 30 configured to receive sensor data 18 from one or more sensors 22. Memory unit 28 may store sensor data 18. Receiver unit 30 can be configured to receive sensor data 18 wirelessly according to any wireless communication standard. The type of wireless communication standard may depend upon the distance between sensors 22 and receiver unit 30. Additionally or alternatively, receiver unit 30 can be configured to receive sensor data 18 through an electrical wire or optical fiber that connects sensors 22 to recording device 24.

In system 20, a common reference time can be created between video recording 16 and sensor data 18. For example, both video recording 16 and sensor data 18 can be time stamped by processor device 32 based on internal clock 34 of recording device 24. Exemplary time stamp 36 is schematically illustrated in FIG. 2. There can be one more time stamps at different times. Processor device 32 can include one or more electronic semiconductor chips and/or signal processing circuitry. Processor device 32 may also include one or more memory devices for volatile and/or non-volatile data storage.

FIG. 3 shows recording device 24 as having camera 26. Alternatively, recording device 24 has no camera. This may be the case when there is no desire to have a video recording of the person included in a report for a physical activity performed by the person.

FIG. 4 shows system 40 for generating a report for a physical activity. Camera 26 communicates directly with one or more sensors 22. Camera 26 is designed mainly for making video recordings, although it has additional functionality that enables it to receive indexing data 42 from one or more sensors 22 while camera 26 produces video recording 16. Optionally, camera 26 can be an infrared camera configured record images based on infrared light. Camera 26 includes receiver unit 30 and processor device 32, which can be as described for FIG. 3. Functionality that enables time stamping is provided by processor device 32. Indexing data 42 can include time stamp 36 which processor device 32 of camera 26 applies to video recording 16 as described for FIG. 2. Memory unit 28 stores video recording 16. Optionally, receiver unit 30 receives sensor data 18 which includes indexing data 42, in which case memory unit 28 may also store sensor data 18.

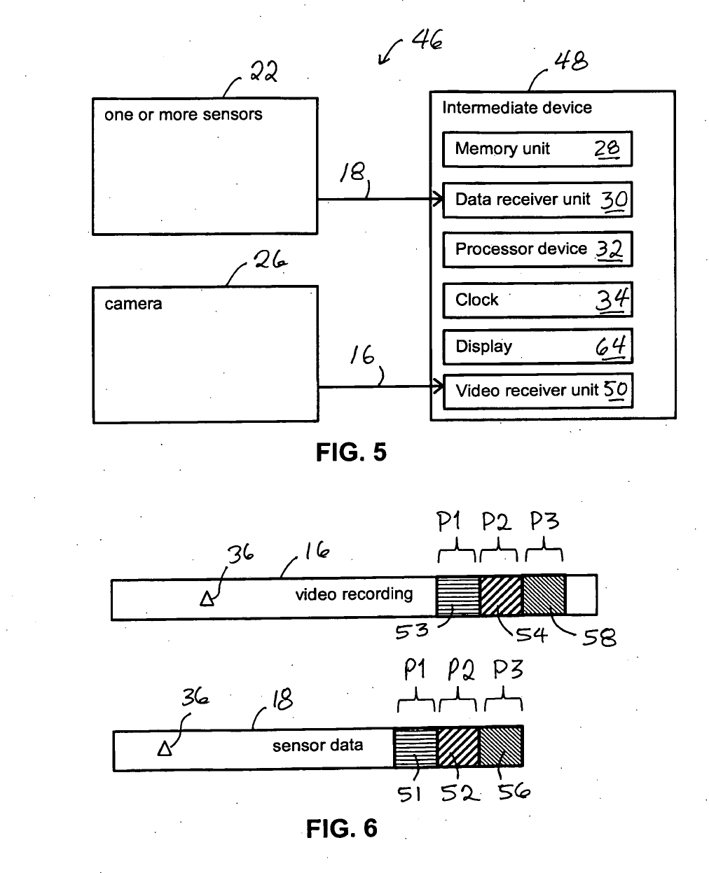

FIG. 5 shows system 46 for generating a report for a physical activity. Camera 26 communicates with intermediate device 48 that communicates with one or more sensors 22. Intermediate device 48 can be for example and without limitation a desktop computer, laptop computer, tablet computer, or a smart phone. Intermediate device 48 simultaneously receives video recording 16 and sensor data 18. Intermediate device 48 includes video receiver unit 50 that is configured to receive video recording 16 from camera 26 while sensor data 18 is being received by receiver unit 30. Receiver unit 30 within intermediate device 48 can be as described above for FIG. 3.

Intermediate device 48 includes processor device 32 and internal clock 34, which can be as described for FIG. 3. Both video recording 16 and sensor data 18 can be time stamped by processor device 32 based on internal clock 34 of recording device 24. Processor device 32 can apply time stamp 36 to video recording 16 and sensor data 18 as described for FIG. 2.

The exemplary systems of FIGS. 3-5 allow the video recording to be correlated with sensor data such that a portion of video recording 16 can be identified based on a portion of sensor data 18 which has been interpreted as being representative of performance of a physical activity with desirable form. Systems configured in other ways can establish a common reference time that allows the video recording to be correlated with sensor data.

The sensor data 18 may correspond to various biomechanical motions corresponding to both physical activities of interest and physical activities which are not interest. The physical activities of interest will depend on what one wishes to study or train. For a sports training example, one may be interested in the activity of shooting a basketball but not the activity of catching a basketball. For a physical therapy or rehabilitation example, one may be interested in the act of standing up from a seated position but not the act of moving one's legs while seated. As discussed below, the physical activity of interest may be targeted by the system to generate a concise report that optionally excludes physical activities that are not of interest.

In further aspects, a method for generating a report for a physical activity includes interpreting a portion of sensor data 18 as being a target data representation of the physical activity. This may include a determination of whether the portion of the sensor data satisfies a criterion for the target data representation. The target data representation can correspond to performance of the physical activity with desirable form. Alternatively, the target data representation can correspond to performance of the physical activity with undesirable form. The method may proceed by identifying a portion of video recording 16 that matches the portion of sensor data 18 that was interpreted as being the target data representation of the physical activity.

As shown in FIG. 6, video recording 16 is produced over multiple periods of time: P1, P2, and P3. Each period of time has a corresponding portion in video recording 16 and sensor data 18, each of which are schematically depicted by a different type of linear shading line. Portion 52 of sensor data 18 at time period P2 may include biometric and/or biomechanical data which has been determined by processor device 32 to have satisfied a criterion for performing the physical activity with desirable form. The criterion will depend on the type of physical activity which is being evaluated. For example, a criterion can be that the angle of the person's elbow (between the upper arm and the forearm) be from 10 to 20 degrees for the type of physical activity being evaluated, and one or more sensors 22 are arranged on the person to provide measurements of the elbow angle. Portion 52 of the sensor data at time period P2 includes measurements of the elbow angle as being 15 degrees, so processor device 32 interprets portion 52 of the sensor data to be a representation of desirable form. Because video recording 18 has been correlated to sensor data 18, processor device 32 can readily identify portion 54 of video recording 18 from the same period of time P2. Processor device 32 refers to time stamp 36, which provides a common reference time, to match portion 52 and portion 54. This enables a coach, a therapist, the person who performed the activity, or other user to view a report that includes portion 54 of video recording 16 showing desirable form. The report may exclude portion 58 of video recording 16 if it is determined that portion 58 shows undesirable form.

In the example above, desirable biomechanical form was being targeted and the criterion that was used was for desirable biomechanical form. The user of the system may wish to target undesirable biomechanical form so as to learn how to recognize and avoid it. For example, portion 56 (FIG. 6) of sensor data 18 at time period P3 may include biometric and/or biomechanical data which processor device 32 has determined to have satisfied a criterion for performing the physical activity with undesirable form. The criterion for undesirable biomechanical form will depend on the type of physical activity which is being evaluated. For example, a criterion for undesirable form can be that the angle at the person's shoulder (between the upper arm and the torso) be less than 15 degrees for the type of physical activity being evaluated, and one or more sensors 22 are arranged on the person to provide measurements of the shoulder angle. Portion 56 of the sensor data at time period P3 includes measurements of the shoulder angle as being 5 degrees, so processor device 32 interprets portion 56 of the sensor data to be a representation of undesirable form. Because video recording 18 has been correlated to sensor data 18, processor device 32 can readily identify portion 58 of video recording 18 from the same period of time P3. Processor device 32 refers to time stamp 36, which provides a common reference time, to match portion 56 and portion 58. This enables a coach, therapist, the person who performed the activity, or other user to view a report that includes portion 58 of video recording 16 showing undesirable form. The report may exclude portions of the video recording 16 which are not of interest, such as portion 56 that shows desirable form.

In the examples above, the criterion for biomechanical form includes a range for elbow angle or shoulder angle. The criterion can also include ranges, upper limits, or lower limits for one or more other types of biomechanical data and/or for one or more biometric data. For example, the criterion may include ranges, upper limits, or lower limits for acceleration of a particular limb, direction of motion of the limb, a level of isometric muscle contraction (or other type of contraction), etc.

One or more sensors 22 can be mounted on a garment or other article configured to be worn on the person's body while performing the physical activity. Examples of garments include without limitation shirts, arm sleeves, vests, leggings, girdles, head caps, and gloves. Other articles configured to be worn on the person's body include without limitation braces, bands (e.g., for wrist, arm, leg, chest, or head), face masks, and other protective equipment such as shin guards, pads (e.g., for knee, elbow, or shoulder), etc.

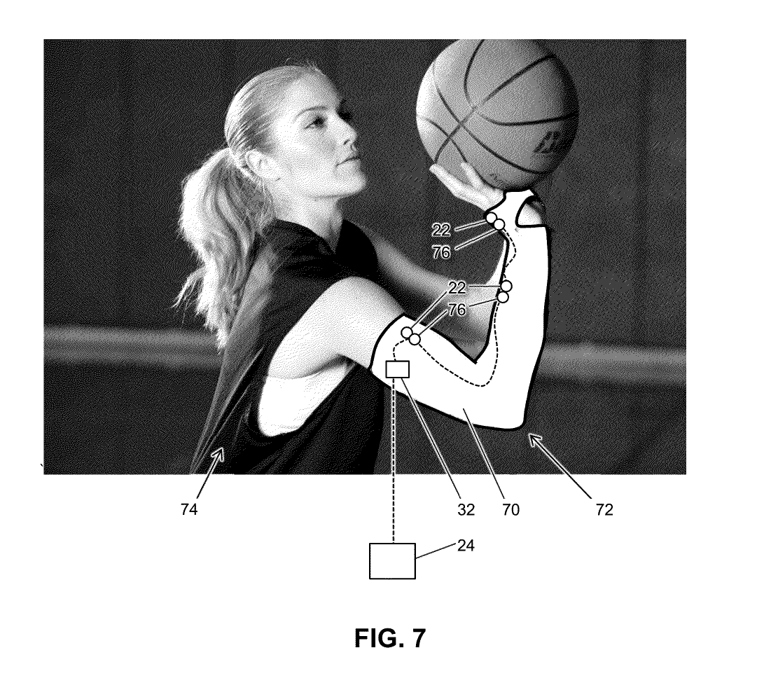

In FIG. 7, one or more sensors 22 are mounted on fabric sleeve 70 which can be worn while playing a sport such as basketball. For example, the sensor/sleeve combination, referred to as training sleeve 72, can provide a basketball player with feedback on jump shots and free throws. Although the sleeve 70 is described below as being worn on a person's arm, a similar sleeve could be worn be worn on the leg or other part of the body with sensors 22 arranged as appropriate for that part of the body.

Sensors 22 attached to fabric sleeve 70 detect the primary shooting arm of athlete 74. Sensors 22 enable processor device 32 to detect when athlete 74 makes a shot toward a basketball hoop (as opposed to another maneuver, such as dribbling the ball) and to analyze the form of the shot. Athlete 74 can receive immediate feedback through audio and visual indicators 76 coupled to sensors 22. Indicators 76 can include lights (e.g., light emitting diodes or lamps) and/or speakers or other device configured to generate a sound. When the athlete's form is incorrect or undesirable, indicators 76 emit a light and/or sound to indicate how to improve the shot. Athlete 74 may also track her performance and compare it to that of teammates using a smartphone app (application program).

Training sleeve 72 includes three sensors 22: one on the back of the hand, one on the forearm, and one on the upper arm. Each sensor 22 comprises a 3-axis accelerometer, a 3-axis gyroscope, and a 3-axis compass which, in combination, accurately track rotation and motion in space using algorithms. Sensors 22 are communicatively coupled to processor device 32 which applies the algorithm to sensor data 18. Sensors 22 are sampled by processor device 32 at around 200 times per second. From sensor data 18, processor device 32 can determine the current rotation of the shoulder, elbow, and wrist.

Processor device 32 uses sensor data 18 from sensors 22 to detect when the athlete makes a shot and analyzes the form of the shot. The detection of a shot and the analysis of the shot are performed by algorithms running in processor device 32. The shot is broken down into many measurable parts, generally measurements in time and space. Measurements can include without limitation joint angles, acceleration, and direction of movement. The reference or heuristic for a “good shot” is based on a set of constraints of these measurable parts. The reference or heuristic for a good shot can be configured from the smartphone app (application program) to personalize for a particular athlete.

As indicated above, athlete 74 can get immediate feedback through audio and visual indicia from indicators 76. Processor device 32 causes indicators 76 to provide immediate feedback after a shot by either playing a sequence of tones and/or by speaking to the player to provide guidance. Lights of indicators 76 can be lit up to indicate what type of mistake may have been made.

Processor device 32 can communicate to a smartphone or other mobile electronic computing device 24 (such as in FIG. 3) using Bluetooth or other wireless communication protocol. This can allow all sensor data 18 from training sleeve 72 to be uploaded into a cloud storage environment. Further analysis as well as tracking of performance over time can be performed either on the smartphone or in the cloud or both. The smartphone can also be used to personalize settings (such as heuristics) for players, as well as to update the software and algorithms running on processor device 32.

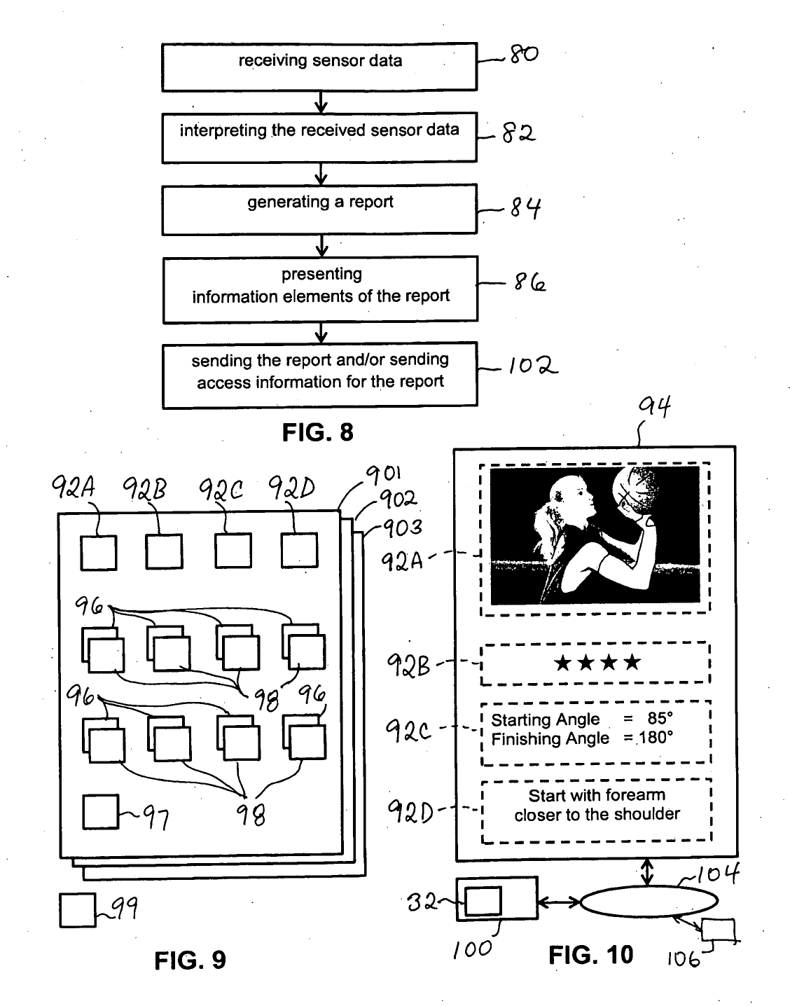

FIG. 8 is a flow diagram showing an exemplary method for generating a report. In block 80, sensor data 18 is received by recording device 24, camera 26 or intermediate device 48 from one or more sensors 22 located on a person performing a physical activity. Sensor data 18 includes biomechanical data, and optionally biometric data, obtained during the physical activity. In block 82, sensor data 18 is interpreted. Data interpretation begins after all sensor data has been received. The interpreting is performed by processor device 32 of device 24, camera 26 or intermediate device 48. The interpreting includes determining, from the received sensor data, a performance quality attribute indicating desirability of how the physical activity was performed by the person. Examples of performance quality attributes are described below.

FIG. 8 shows block 82 after block 80. Processor device 32 can start interpreting sensor data 18 after all portions have been produced by the sensors. For example, processor device 32 starts interpreting sensor data 18 within 10 seconds or within 1 minute after the sensors have completed producing sensor data 18 entirely. As a further example, processor device 32 starts interpreting the sensor data hours or days after the sensors have completed producing the sensor data entirely.

Although block 82 is shown after block 80, it is also possible for earlier portions of the sensor data to be interpreted while later portions of sensor data are being received. This may allow the report to be generated more quickly after all sensor data is received. Thus in further aspects, a method for generating a report for a physical activity includes interpreting sensor data 18 while sensor data 18 is being produced by one or more sensors 22. For example, processor device 32 can start interpreting portion 51 (FIG. 6) of sensor data 18 at time period P1 before other portions 52 and/or 56 are produced by one or more sensors 22.

Referring again to FIG. 8, in block 84 a report is generated. The report includes a plurality of information elements capable of being presented simultaneously on a presentation device, such as presentation device 94 in FIG. 10. The report may be a multimedia report. A multimedia report is defined as a report that includes two or more of types of information, the types being: text, images (video and/or still images) and audio. For example, one of the information elements may be text while another information element may be an image. Presentation device 94 can be recording device 24, camera 26, intermediate device 48, or other device. Any of these devices can be mobile electronic device, such as a smartphone or tablet computer.

A process for interpreting sensor data (such as block 82 in FIG. 8) optionally includes developing a recommendation for improving the performance quality attribute. In a sports training example, the recommendation may be an instruction to the person to start the basketball shot with his/her forearm closer to the shoulder. In a physical rehabilitation example, the recommendation may be an instruction to the person to tilt his/her torso forward slightly when standing up from a seated position. At least one of the information elements represents the recommendation. This allows the recommendation to be part of the report may be presented to the person, coach, or therapist.

The method optionally comprises presenting the plurality of information elements on presentation device 94, as shown for example in block 86. Presentation device 94 can be recording device 24, camera 26, intermediate device 48, or other device. Optionally, the received sensor data are represented by at least some of the information elements of the report. This allows certain biomechanical measurements (such as angles between parts of the person's body, speed or acceleration of parts of the person's body) to be part of the report and then presented for review by the person who performed the physical activity or to another person.

The terms “presented” and “presenting,” as used with information elements of the report, encompasses visual presentation of one or more information elements. For example, graphical symbols, text, static images, and/or video images may be shown on a display to communicate information about the physical activity that was performed. For example, the display can be display 64 (FIGS. 3-5). Display screen 64 can be a liquid crystal display screen, light emitting diode display screen, other type of electronic display. As a further example, processor device 32 can visually present information elements of the report on a display screen external to recording device 24, camera 26 and intermediate device 48. An external display screen can be a projector screen fabric, a liquid crystal display screen, light emitting diode display screen, other type of electronic display.

The terms “presented” and “presenting,” as used with information elements of the report, also encompasses audible presentation of one or more information elements. Audible presentation is defined as presentation that can be normally heard by human. For example, a sound, speech converted from text, and/or pre-recorded speech may broadcasted by speaker (or other device configured to generate a sound) to audibly communicate information about the physical activity that was performed. The speaker or other device configured to generate a sound can be contained in recording device 24, camera 26 or intermediate device 48.

The method for generating the report optionally comprises receiving video recording 16 and correlating sensor data 18 with video recording 16, as shown form example in block 12 of FIG. 1. The video recording shows the person performing the physical activity. Optionally, the received video recording is represented by at least some of the information elements of the report. This allows selected portions of the video recording (such as portions 53, 54, and/or 58 in FIG. 6) to be part of the report and then presented for review by the person who performed the physical activity or to another person. Processor device 32 may select certain portions for inclusion into the report based on report templates and interpretation of sensor data 18.

The process of determining of the performance quality attribute (such as in block 82 of FIG. 8) optionally includes applying a criterion for biomechanical form for performing the physical activity. As previously described, the criterion can be for desired or undesirable biomechanical form, depending on what one wishes to target. For example, the performance quality attribute may be a numerical value indicating closeness of the performed physical activity to the criterion for biomechanical form. When the report is presented on presentation device 94, the performance quality attribute may be visually displayed as a number, text, symbol, or graphic corresponding to the numerical value of the performance quality attribute. As a further example, the performance quality attribute may be presented in an auditory manner, such as a tone, speech, or other sound corresponding to the numerical value of the performance quality attribute. The numerical value can be represented by an alphanumeric character string or other code.

A process of interpreting the received sensor data (such as in block 82 of FIG. 8) optionally includes comparing the sensor data for the physical activity to that of the same physical activity performed previously by the same person. This can allow the performance quality attribute to indicate desirability of how the physical activity was performed relative to the previous performance of the same physical activity.

For example, the performance quality attribute could indicate that performance of the physical activity at time period P2 (FIG. 6) is more desirable (or closer to the criterion for desirable biomechanical form) than the performance of the physical activity at time period P3. As another example, the performance quality attribute could indicate that performance of the physical activity at time period P1 (FIG. 6) is desirable (or closer to the criterion for desirable biomechanical form) because it was a personal best. That is, the performance at P1 was closer to the criterion for desirable biomechanical form than all previous records for the same physical activity performed by the same person. As a further example, the performance quality attribute could indicate that performance of the physical activity at time periods P1, P2, and P3 (FIG. 6) are less desirable (or further from the criterion for desirable biomechanical form) when averaged together, as compared to performances of the same physical activity during a previous training session by the same person.

A process of interpreting the received sensor data (such as in block 82 of FIG. 8) optionally includes comparing the sensor data for the physical activity to that of the same physical activity performed previously by a second person. This can allow the performance quality attribute to indicate desirability of how the physical activity was performed relative to another person, such as somebody else in the same sports team.

For example, the performance quality attribute could indicate that performance of the physical activity at time periods P1, P2, and P3 (FIG. 6) are less desirable (or further from the criterion for desirable biomechanical form) when averaged together, as compared to performances of the same physical activity during a previous training session by another person. As a further example, the performance quality attribute could indicate that performance of the physical activity at time period P3 (FIG. 6) is less desirable (or further from the criterion for desirable biomechanical form) than a performance of the same physical activity performed by another person.

A process for generating a report (such as in block 84 in FIG. 8) optionally comprises associating a personal identifier to the received sensor data. This can allow processor device 32 to distinguish the received sensor data from previously received sensor data associated with a different personal identifier for another person, for the purpose comparing performance of the physical activity with another person.

A process for generating a report (such as block 84 in FIG. 8) is optionally performed according to a report template that specifies presentation formats for the information elements of the report. Each presentation format is any one or a combination of audible presentation, text presentation, static image presentation, and video image presentation. Audible presentation is defined as presentation that can be heard by a human. For example, a sound, speech converted from text, and/or pre-recorded speech could be broadcasted by a speaker (or other device configured to generate a sound) to audibly communicate information about the physical activity that was performed. Conversion of text (such as text for a performance quality attribute, a recommendation, or a biomechanical measurement value) may be performed by a conversion application program or algorithm executed by processor device 32. Text presentation is defined as visual presentation of numeric, alphabetic, alphanumeric, and/or other types of character sets (e.g., for Arabic and Asian languages) used in written communication. Static image presentation is defined as visual presentation of a still image, such as a symbol, drawing, schematic illustration, and/or photograph. Video image presentation is defined as visual presentation of an image that changes over time, such as animation and a video recording. Static and video image presentation can be performed by an electronic display screen, image projector, or other device.

FIG. 9 shows three different report templates 901, 902, and 903. Only details of the first report template 901 are shown, and it should be understood that the other report templates 902 and 903 include information elements, rules, and assets like first report template 901, but those information elements, rules, and assets vary from those in report template 901. Report templates are stored in a memory device (e.g., memory unit 28 in FIGS. 3-5) accessible by processor device 32.

Report template 901 includes four information elements 92A, 92B, 92C, and 92D. Report template 90 specifies video image presentation for information element 92A, which can represent a video image of the person performing the physical activity or an animated drawing that illustrates a biomechanical motion associated with the physical activity. Report template 901 specifies static image presentation for information element 92B, which can be a bar graph representing a performance quality attribute indicating desirability of how the physical activity was performed by the person. Report template 901 specifies text presentation for information element 92C, which may show numerical values representing biomechanical measurements taken while the physical activity was performed. Report template 901 specifies text presentation and audible presentation for information element 92D, which may represent a recommendation to be presented to the person for improving the performance quality attribute. Text for the recommendation is presented. Also, the text may be converted to speech so that the recommendation is presented audibly.

Although FIG. 9 show four information elements for report template 901, it is to be understood that other report templates 902 and 903 may include a lesser or greater number of information elements and may specify presentation formats that differ from report template 901.

A process for interpreting sensor data (such as in block 82 in FIG. 8) optionally includes deriving a value for a biomechanical measurement from the biomechanical data included in sensor data 18. The value may be compared to a criterion to determine a performance quality attribute. Report template 901 may specify the biomechanical measurement for inclusion in the report. A process for generating of the report (such as in block 84 of FIG. 8) optionally includes populating one of the information elements of the report with the value of the biomechanical measurement. That is, the value is assigned by processor device 32 to one of the information elements.

FIG. 10 illustrates a report presented on presentation device 94 according to report template 901 of FIG. 9. FIG. 10 shows information elements for one performance of a physical activity. The report optionally includes information elements for additional performances of the same or different physical activity. For example, what is shown in FIG. 10 may correspond to a first page of the report, and there may be additional pages for other performances of the same or different physical activity. Alternatively, information elements for multiple performances of a physical activity may be presented simultaneously by presentation device 94

Referring again to FIG. 10, a processor device (e.g., device 32 in FIGS. 3-5 or device 32 of computer server in FIG. 10) has populated information element 92A with video recording 16 showing the person performing the physical activity during which sensor data 16 was collected.

The processor device has populated information element 92B with the performance quality attribute. Presentation device 94 presents the performance quality attribute, according to report template 901, as a still image. The still image includes stars which represent a rating or scale indicating how well the person performed the physical activity in relation to one or more criteria for biomechanical form for that physical activity. Alternatively, template 901 may specify text and audible presentation for the performance quality attribute of information element 92B. Examples of text and audible presentation include text and speech stating “below average,” “average,” “above average,” or “personal best.”

The processor device may derive a biomechanical measurement from the biomechanical data included in sensor data 18 obtained from one or more sensors 22. For example, the biomechanical measurement is the angle between the person's forearm below the elbow and the upper arm above the elbow. Report template 901 specifies that the angle at the start of the physical activity (starting angle) and at the end of the physical activity (finishing angle) be included in report. The processor device generates the report by populating information element 92C with the starting angle and finishing angle. Report template 901 specifies text presentation for information element 92C, so presentation device 94 shows the finishing angle and starting angle as text.

Report template 901 may specify a conditional requirement for the biomechanical measurement, and generating of the report (such as in block 84 in FIG. 8) includes determining whether the conditional requirement is satisfied by the value for the biomechanical measurement. Populating an information element with the value of the biomechanical measurement is performed only when the conditional requirement is satisfied. For example, it may be desired to communicate aspects of the physical activity that need improvement. The conditional requirement may be that the value of the biomechanical measurement be outside of a desired range. Only if the value of the biomechanical measurement be outside of a desired range, the information element of the report is assigned the value of the biomechanical measurement.

Report template 901 optionally includes rule 96 for one or more assets 98. Each rule 96 may be an algorithm or computer instructions. Although one rule 96 is shown for every asset 98, it is to be understood that one rule 96 may apply to multiple assets 98, or multiple assets 98 may be associated with only a single rule 96. The term “rule” refers to one or more rules.

Each asset 98 is any one of a text, audio, a static image, animation, and a video recording. Each asset 98 has been recorded before the sensor data is received and interpreted. Generating the report (such as in block 84 in FIG. 8) includes populating one or more of the information elements of the report with the one or more assets according to rule 96. Optionally, rule 96 for the one or more assets 98 refers to the sensor data. This may allow assets 98 to be selectively added to or excluded from the report based on actual performance of the physical activity.

For example, one of the assets 98 may by a video recording showing an expert performing the physical activity properly. Rule 96 associated with that asset may require that, when a performance quality attribute is extremely low (e.g., performance of the physical activity is very different from a criterion for desirable biomechanical form), information element 92A (FIG. 10) is populated by processor device 32 with video recording 16 of the person performing the physical activity and the video recording showing an expert performing the physical activity for purposes of comparison.

Some of the assets 98 could be different recommendations in text form. Rule 96 associated with those assets 98 may establish conditions for when information element 92D (FIG. 10) is populated by processor device 32 with the recommendations. For example, rule 96 may require information element 92D to be populated with a first recommendation when a biomechanical measurement is within a first range, and may also require information element 92D to be populated with second recommendation when the biomechanical measurement is within a second range. As a further example, rule 96 may require information element 92D to be populated with a first recommendation when a first biomechanical measurement is not within its desirable range, and may also require information element 92D to be further populated with a second recommendation when a second biomechanical measurement is not within its desirable range.

A process for generating a report (such as in block 84 in FIG. 8) optionally includes receiving video recording 16 showing the person performing the physical activity. The method optionally includes a processing for correlating (such as in block 14 in FIG. 1) sensor data 18 with video recording 16. Report template 901 may include video rule 97 for video recording 16. Generating the report (such as in block 84 in FIG. 8) may include adding video recording 16 to the report according to video rule 97. Optionally, video rule 97 for refers to sensor data 18.

For example, it may be desired to communicate aspects of the physical activity that are performed well, as determined by processor device 32 from sensor data 18. Video rule 97 may require that a portion of video recording 16 which shows the physical activity being performed with desirable biomechanical form (e.g., video portion 58 in FIG. 6) be included in the report, and may require exclusion of portions of the video recording that show undesirable biomechanical form. This may allow the person performing the activity to quickly view only good examples of his/her performance. Also, this may allow conservation of computing resources and/or memory storage space.

Report template 901 may be generated from instructions from the person (who is to be performing the physical activity) before the physical activity is performed. For example, the person may use an application program executed by processor device 32 to select information elements from a menu of various information elements, such that the selected information elements will be included in the report. The person may choose to omit information element 92A (for presenting a video image of the performance of the physical activity) from the report, and may choose to include information element 92D (for presenting a recommendation). The person may also select one or more presentation formats from a menu of various presentation formats, for each of the selected information elements. The person may choose audible presentation format for information element 92B (for presenting a performance quality attribute).

Report template 901 could be one of a set of report templates available for generating the report. For example, the person may use an application program executed by processor device 32 to select report template 901 from a menu of various report templates that includes templates 901, 902, 903, and possibly more.

As a further example, processor device 32 may select report template 901 from various available report templates without intervention from the person. Selection is performed according to template selection rule 99 that refer to one or more variables. The variables can be one or more of the performance quality attribute, availability of video recording showing the person performing the physical activity, frequency of use of the report template for the person performing the physical activity, and level of change in performance quality attribute in response to prior use of the report template. Template selection rule 99 may be an algorithm or computer instructions embedded in processor device 32 or part of an application program executed by processor device 32.

For example, if the performance quality attribute is extremely low (e.g., performance of the physical activity is very different from a criterion for desirable biomechanical form), processor device 32 may select, according to rule 99, a report template that specifies a relatively large number of biomechanical measurements to be presented as part of the report, as compared to a situation where the performance quality attribute is high. In another example, if no video recording was generated at all or if no video recording is correlated with a portion of sensor data 18 of interest, then a report template which does not require presentation of a video recording is selected.

Preference for certain report templates may be inferred by processor device 32 from the frequency of prior selection of those report templates by the person performing the physical activity. The next time the same physical activity is performed, processor device 32 selects, according to rule 99 and without intervention from the person, the report template having the highest frequency of prior use. Alternatively, processor device 32 may select, according to rule 99, the report template which does not have the highest frequency of prior use, so as to provide the person with different information elements and/or different presentation formats in order to increase interest with varying forms of feedback.

Processor device 32 may track a level of change in the performance quality attribute in response to prior use of a report template. If improvement in the performance quality attribute is slow or has reached a plateau, it may be helpful to provide different feedback to the person performing the physical activity. Processor device 32 may, according to rule 99 and without intervention from the person, select a report template having different information elements and/or different presentation formats than what the person used previously.

As indicated above, template selection rule 99 may refer to multiple variables, such as performance quality attribute, availability of video recording showing the person performing the physical activity, frequency of use of the report template for the person performing the physical activity, and level of change in performance quality attribute in response to prior use of the report template. That is, selection of a particular report template 901, 902, or 903 can be based on one or more of these variables. Optionally, each variable provides a weight for selection of the report template with a weighted-random function. That is, template selection rule 99 may randomly assign a weight to each one of the variables prior to generating the report. This may allow selection by processor device 32 to be somewhat different from one training session to the next, or from one performance of the physical activity to the next performance of the physical activity. For example, a first report may be limited to presentation of elbow and wrist angles as information elements, and the next report limited to presentation of angular acceleration of forearm and hand as information elements.

Generating of the report may be performed according to an application program running in presentation device 94. Alternatively, generating of the report is performed by computer server 100 separate from presentation device 94.

A method for generating a report may include a process (such as in block 102 in FIG. 8) for sending the report to presentation device 94. The report sent to presentation device 94 can be in the form of an electronic data file, such as a digital multimedia format (e.g., MPEG-4), text only format, audio only format, or a combination of formats which may be assembled by presentation device 94. In addition or alternatively, the report is sent to a social networking service that is accessible to presentation device 94 via network 104. Social networking service may be hosted, at least in part, on computer server 106 separate from presentation device 94. The social networking service is a platform that allows the person to build social networks or social relations with other people, and such networks or relations may be based on shared interests or activities. A social network service may include a representation of each user (referred to as profile). Processor device 32 may send the report to the profile of the person (the subject) who performed the physical activity or to profiles of other people linked to the profile of the subject. Examples of a social networking service include without limitation Facebook™, Twitter™, and Instagram™.

Additionally or alternatively, the process in block 102 may include a process for sending access information to presentation device 94. The access information enables presentation device 94 to access the report from a memory device that stores the report and that is separate from presentation device 94. The memory device can be contained within server 100 (FIG. 10). For example, the access information may be a hyperlink. In general, a hyperlink is a reference to data that the reader (the user of presentation device 94 in this case) can directly follow either by clicking or by hovering. As a further example, the access information may be a Uniform Resource Locator (URL) or other type of reference address to a resource for the report. In addition or alternatively, the access information is sent to a social networking service that is accessible to presentation device 94 via network 104.

In any aspect herein, including aspects described in connection with any of the figures and methods herein, recording device 24, camera 26, intermediate device 48, presentation device 94, computer server 100 includes a computer processor device capable of executing, in accordance with a computer program stored on a non-transitory computer readable medium, any one or a combination of the steps and functions described above for generating a report. The non-transitory computer readable medium may comprise instructions for performing any one or a combination of the steps and functions described herein, including those described above for generating a report. Processor device 32 and/or memory unit 28 may include the non-transitory computer readable medium. Examples of a non-transitory computer readable medium includes without limitation non-volatile memory such as read only memory (ROM), programmable read only memory, and erasable read only memory; volatile memory such as random access memory; optical storage devices such as compact discs (CDs) and digital versatile discs (DVDs); and magnetic storage devices such as hard disk drives and floppy disk drives.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A method for generating a report, the method comprising:
receiving sensor data from at least one sensor located on a person performing a physical activity, the sensor data including biomechanical data obtained during the physical activity;
interpreting the sensor data, the interpreting performed by a processor, the interpreting including determining, from the sensor data, a performance quality attribute indicating desirability of how the physical activity was performed by the person; and
generating a report that includes a plurality of information elements capable of being presented on a presentation device, wherein the performance quality attribute is represented by at least a first one of the information elements.

2. The method of claim 1, wherein the interpreting of the sensor data includes developing a recommendation for improving the performance quality attribute, and at least one of the information elements represents the recommendation to be presented to the person as part of the report.

3. The method of claim 1, further comprising presenting the plurality of information elements on the presentation device, wherein the sensor data are represented by at least a second one of the information elements.

4. The method of claim 1, further comprising receiving a video recording showing the person performing the physical activity and correlating the sensor data with the video recording, wherein the video recording is represented by at least a another one of the information elements.

5. The method of claim 1, wherein the determining of the performance quality attribute includes applying a criterion for biomechanical form for performing the physical activity.

6. The method of claim 1, wherein the interpreting includes comparing the sensor data for the physical activity to that of the same physical activity performed previously by the same person, and the performance quality attribute indicates desirability of how the physical activity was performed relative to the previous performance of the same physical activity.

7. The method of claim 1, wherein the interpreting includes comparing the sensor data for the physical activity to that of the same physical activity performed previously by a second person, and the performance quality attribute indicates desirability of how the physical activity was performed relative to the previous performance of the same physical activity performed by the second person.

8. The method of claim 1, wherein the generating of the report is performed according to a report template that specifies presentation formats for the information elements of the report, and each presentation format is any one or a combination of audible presentation, text presentation, static image presentation, and video image presentation.

9. The method of claim 8, wherein the interpreting includes deriving a value of a biomechanical measurement from the biomechanical data, the report template specifies the at least one biomechanical measurement, and the generating of the report includes populating one of the information elements of the report with the value of the biomechanical measurement.

10. The method of claim 8, wherein the report template specifies a conditional requirement for the biomechanical measurement, and the generating of the report includes determining whether the conditional requirement is satisfied by the value for the biomechanical measurement and the populating of the information element with the value of the biomechanical measurement is performed only when the conditional requirement is satisfied.

11. The method of claim 8, wherein the report template includes a rule for one or more assets, each asset being any one of a text, audio, a static image, and a video recording, and each asset has been recorded before the receiving and interpreting of the sensor data, and the generating of the report includes populating one or more of the information elements of the report with the one or more assets according to the rule.

12. The method of claim 11, wherein the rule for the one or more assets refers to the sensor data.

13. The method of claim 11, wherein at least one of the assets is a recommendation to be presented to the person for improving the performance quality attribute.

14. The method of claim 8, further comprising receiving a video recording showing the person performing the physical activity and correlating the sensor data with the video recording, wherein the report template includes a video rule for the video recording, and the generating of the report includes adding the video recording to the report according to the video rule.

15. The method of claim 14, wherein the video rule for the video recording refers to the sensor data.

16. The method of claim 8, wherein the report template was generated from instructions from the person performing the activity.

17. The method of claim 8, wherein the report template is one of a set of report templates available for generating the report.

18. The method of claim 17, further comprising selecting the report template from the set of report templates, the selecting performed by the processor according to a template selection rule referring to one or more variables, the one or more variables being one or more of the performance quality attribute, availability of video recording showing the person performing the physical activity, frequency of use of the report template for the person performing the physical activity, and level of change in performance quality attribute in response to prior use of the report template.

19-24. (canceled)

25. A system for generating a report, the system comprising:
a means for receiving sensor data from at least one sensor to be placed on a person performing a physical activity, the sensor data including biomechanical data obtained during the physical activity;
a means for interpreting the sensor data, the interpreting including determining, from the sensor data, a performance quality attribute indicating desirability of how the physical activity was performed by the person; and
a means for generating a report that includes a plurality of information elements capable of being presented on a presentation device, wherein the performance quality attribute is represented by at least a first one of the information elements.

26. A non-transitory computer readable medium having a stored computer program embodying instructions, which when executed by a computer system, causes the computer system to provide a report for a physical activity, the computer readable medium comprising:
instructions for receiving sensor data from at least one sensor to be placed on a person performing a physical activity, the sensor data including biomechanical data obtained during the physical activity;
instructions for interpreting the sensor data, the interpreting including determining, from the sensor data, a performance quality attribute indicating desirability of how the physical activity was performed by the person; and
instructions for generating a report that includes a plurality of information elements capable of being presented on a presentation device, wherein the performance quality attribute is represented by at least a first one of the information elements.
